(19) United States
(12) Patent Application Publication
(10) Pub. No.: US 2014/0096146 A1
(43) Pub. Date: Apr. 3, 2014

(54) TRANSLATING TIME-STAMPED EVENTS TO PERFORMANCE INDICATORS

(71) Applicant: HEWLETT-PACKARD DEVELOPMENT COMPANY, L.P., Houston, TX (US)

(72) Inventors: Alina Maor, Haifa (IL); Ron Maurer, Haifa (IL); Michal Lavi, Nes Ziona (IL)

(73) Assignee: HEWLETT-PACKARD DEVELOPMENT COMPANY, L.P., Houston, TX (US)

(21) Appl. No.: 13/629,930

(22) Filed: Sep. 28, 2012

(51) Int. Cl. G06F 9/46

(52) U.S. Cl. 719/318

(57) ABSTRACT

Systems and methods for translating time-stamped events to performance indicators are provided. A data component can receive sequences of time-stamped events associated with a device with a set of subsystem components. A conversion component can convert the sequences to time series based upon log transformations of event-intervals associated with the events. An estimation component can estimate local event-descriptor distribution characteristics at an event count associated with the time series. A translation component can translate the local event-descriptor distributions characteristics into performance indicators.

### BACKGROUND

When monitoring the performance or health of a complex system that includes a large number of dynamic and possibly dynamically interacting sub-components, a number of difficulties arise. For example, conventional monitoring systems examine events (e.g., errors) issued by the devices and determine an event-rate, which is essentially a calculation of the number of events per unit of time. Event-rate computation is traditionally based on a count of the events for the devices being monitored over a fixed time span (e.g., a “time-window”).

A fundamental difficulty with this approach to performance monitoring deals with the selection of the time-window that will be used for evaluation. Since event-rate data provided by the devices can include event time-intervals that span about six orders of magnitude, there is an inherent trade-off between the temporal resolution and estimation accuracy. Hence, it is rarely possible to find a single time-window with an optimal trade-off at all time-frames.

Conventional attempts to mitigate this difficulty relate to either multi-resolution rate estimation or adaptive window sizing. However, these potential solutions assume a number of constraints that are not expected to hold in practice for many systems. For example, these potential solutions only apply to data that obeys simple parametric distributions such as Poisson distributions, and further assume quasi-stationarity (e.g., piecewise constant rate). In addition, sophisticated rate-estimation algorithms are required that are computationally complex and taxing to system resources.

In addition, even provided a certain measure of performance, it is not always clear how to determine an individual system performance. This occurs since system behavior may vary and change arbitrarily rapidly or gradually, due to, e.g., different operational modes, loads or external conditions. In cases of such varying performance, conventional threshold-based techniques cannot be applied simply because it is unclear which dynamic thresholds adaptations are required due to modeling difficulties under such conditions.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a high-level block diagram of an example system that translate time-stamped events to performance indicators in accordance with certain embodiments of this disclosure;

FIG. 2A depicts an example block representation of time stamps illustrating various example types or formats of time stamps associated with events that can be included in the sequences in accordance with certain embodiments of this disclosure;

FIG. 2B depicts an example block representation illustrating various example types of events for which associated data can be included in the sequences in accordance with certain embodiments of this disclosure;

FIG. 2C depicts an example block representation illustrating various example types of event-descriptors in accordance with certain embodiments of this disclosure;

FIG. 3 illustrates a block diagram of a system in which data associated with event logs are included in sequences received by the data component in accordance with certain embodiments of this disclosure;

FIG. 4 illustrates a block diagram of a system that can provide additional detail in connection with estimation components and translation components in accordance with certain embodiments of this disclosure;

FIG. 5 illustrates a block diagram of a system that can provide for mode analysis and output presentation in connection with translating time-stamped events to performance indicators in accordance with certain embodiments of this disclosure;

FIGS. 6A-8B relate to various example illustrative graphs and/or graphical representations of data in accordance with certain embodiments of this disclosure;

FIG. 9 illustrates an example methodology that can provide for constructing performance indicators based upon time-stamped events in accordance with certain embodiments of this disclosure;

FIG. 10 illustrates an example methodology that can provide for additional features associated with constructing performance indicators based upon time-stamped events in accordance with certain embodiments of this disclosure;

FIG. 11 illustrates an example schematic block diagram for a computing architecture in accordance with certain embodiments of this disclosure; and

FIG. 12 illustrates an example block diagram of a computer operable to a communications framework to execute certain embodiments of this disclosure.

### DETAILED DESCRIPTION

### Overview

One advantage of the subject matter disclosed herein can relate to improving the local or remote service management of a complex device (composed of different, possibly interacting, subsystems) that require system-health or system-performance evaluation from the system data logs. Typically, system logs associated with the device report selected “undesirable” events such as errors, warnings, or tuning requirements from different parts of the system. These events are typically unavoidable in the course of normal system operation for a given device operating with a high load. Some of these events are handled locally by the customer without special service attention (e.g., a paper jam); yet still incur costs in terms of parts, materials, and loss of productivity. Other, more severe, reported events require technical service specialists to visit the site, which is even more costly. Hence, when undesirable events occur too often, the system can be said to have reduced performance in terms of productivity and production cost efficiency. The same can be said when desirable events, such as production, occur too seldom. In these two event-types (desirable versus undesirable), analysis techniques can be similar, but the definition of good performance versus bad performance with relation to the event frequency is reversed.

Service organizations that manage these devices or subsystems on behalf of the customer can therefore benefit from having a timely estimation of the personalized performances for all systems/devices they service. Such can lead to improving their own resource usage, improving service effectiveness for their customers, and reducing productivity loss to their customers.

In part, these service organizations can benefit in a variety of ways. For example, by identifying slowly evolving problems and repairing those problems before escalation by way of, e.g., proactive maintenance. As another example, these service organizations can benefit by adapting planned maintenance schedules that are contingent on actual system performance. It is noted that devices and/or systems issued by the same provider (and are substantially identical) may vary greatly in the performance witnessed by the customer (e.g., due to different use schedules, environments, etc.) Hence, two such devices are not necessarily comparable in performance and individual device performance can be more relevant for performance monitoring than global performance metrics.

When attempting to provide performance measures and/or performance indicators that might serve as the basis to the above, it noted that the available event logs from the device being monitored can contain only a small portion of the monitoring data collected by monitoring systems in real time. In particular, these event logs generally include the “problematic” part of the operation. Therefore, in terms of the operation time of the associated devices, there is underrepresentation of normal operation times relative to “problematic” times. Hence, normal periods are mainly identified by lack of reported events, not by any positive indication.

As such, one difficulty that arises is that actual data of time-intervals between successive events can vary between very small (e.g., frequent problems) to very large (e.g., long periods of flawless operation without any intermediate indication). These types of data tend to have statistically challenging distributions of inter-event intervals; in particular, heavy-tailed, multi-modal mixtures, and dynamically changing distributions which pose a challenge to many statistical analysis methods. Such statistically challenging distributions may, in fact, arise not only while considering event-intervals, but also when considering other event-related information, such as event-duration or time to resolution of an incident that issued a certain event.

Another requirement of a performance monitoring system is to have criteria for interpretation of the performance-metric values. In traditional approaches, global performance-criteria for different performance-modes (e.g. “bad”/“medium”/“good”) are set based on system-expert experience with a variety of similarly behaving systems. Due to the scarcity of system-experts and their limited capability to adapt the performance-criteria to changing system characteristics over time, there is a need for automatic determination of the performance criteria from the data itself.

Furthermore, in typical complex systems with a large variety of operation modes and workloads, global performance criteria are insufficiently adaptive and setting performance-alarms by these global criteria may give rise to high rates of false alarms or misdiagnoses. Hence, there is a need for continuous automatic setting of performance criteria adaptive to each individual system over time. While there are known methods from the field of statistical process control to address the continuous setting of performance criteria (such as “six-sigma”), they are designed for data with well-behaved statistics (uni-modal, non-heavy-tailed, quasi-static), and do not work well for the statistically challenging event-descriptors data. Hence, there is a need for a data-driven statistical analysis method to determine the performance criteria that addresses all the statistical challenges found in event-descriptor data—multi-modality, highly dynamic statistical changes, heavy-tails, etc.

Another challenge relative to traditional “statistical process control” (SPC) is the definition of “healthy” performance mode. Unlike in traditional SPC, the mode of the event-descriptor distribution that corresponds to the desired “healthy” performance need not be a main mode or the most probable mode. Rather, the system being monitored can be in a “healthy” state for only a relatively small portion of the time (e.g., 10%). As such, there is a need for an alternative performance mode analysis technique to detect multiple modes, some with small masses, and in particular to detect the extreme modes (e.g., highest/lowest event-rates) to characterize the performance-bounds, and set adaptively performance criteria.

To these and other related ends, the disclosed subject matter relates to distinct data-driven analysis (in contrast to conventional event-count driven models) for monitoring system performance relative to either short-term or long-term history. Event-occurrence data with challenging statistics can be converted into system-health indicators corresponding to smoother event-descriptive distribution signals. Event-descriptive bounds corresponding to good/bad health can be system-adaptive. Embodiments can include a distinct transformation of event-occurrence data into generalized time-series, and a distinct data-driven estimation to determine performance bounds adaptive to historical-data. This performance bound determination can handle the challenging scenario of multiple small operation modes, including some operation modes with heavy-tailed distributions. The disclosed subject matter can be, e.g., broadly applicable to different types of systems that report event-logs such as computers, mechanical/electronic complex equipment, digital systems, medical monitoring, etc.

### Determining Performance Indicators

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

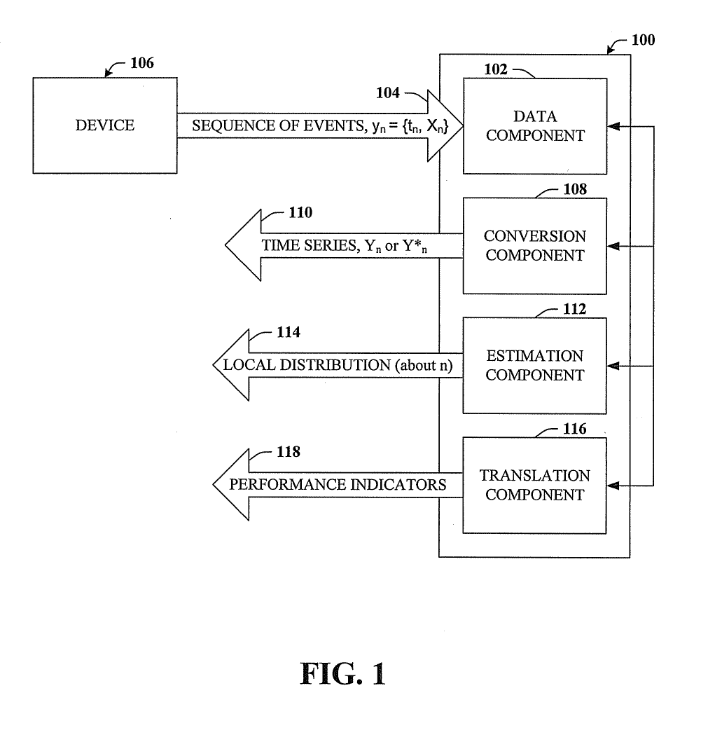

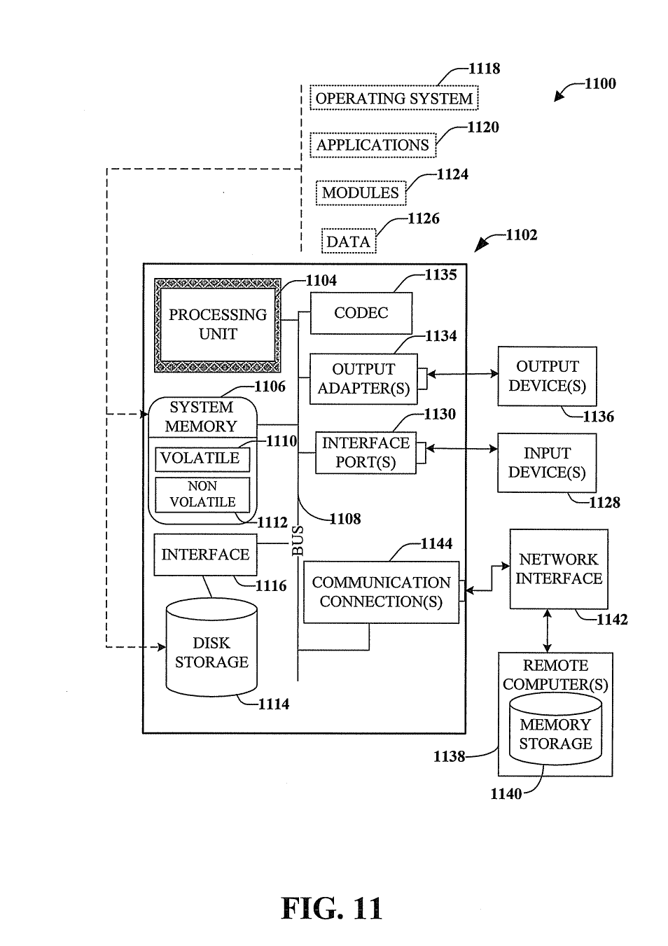

Referring now to FIG. 1, system 100 is depicted. System 100 can translate time-stamped events to performance indicators. Embodiments disclosed herein can, for example, identify slowly evolving problems, enable more efficient maintenance scheduling, identify devices that require special attention or a change in operation role, identify related performance issues, and so forth. System 100 can include a memory that stores computer executable components and a processor that executes computer executable components stored in the memory, examples of which can be found with reference to FIG. 11. It is to be appreciated that the computer 1102 can be used in connection with implementing one or more of the systems or components shown and described in connection with FIG. 1 and other figures disclosed herein. As depicted, system 100 can include a data component 102, a conversion component 108, an estimation component 112, and a translation component 116.

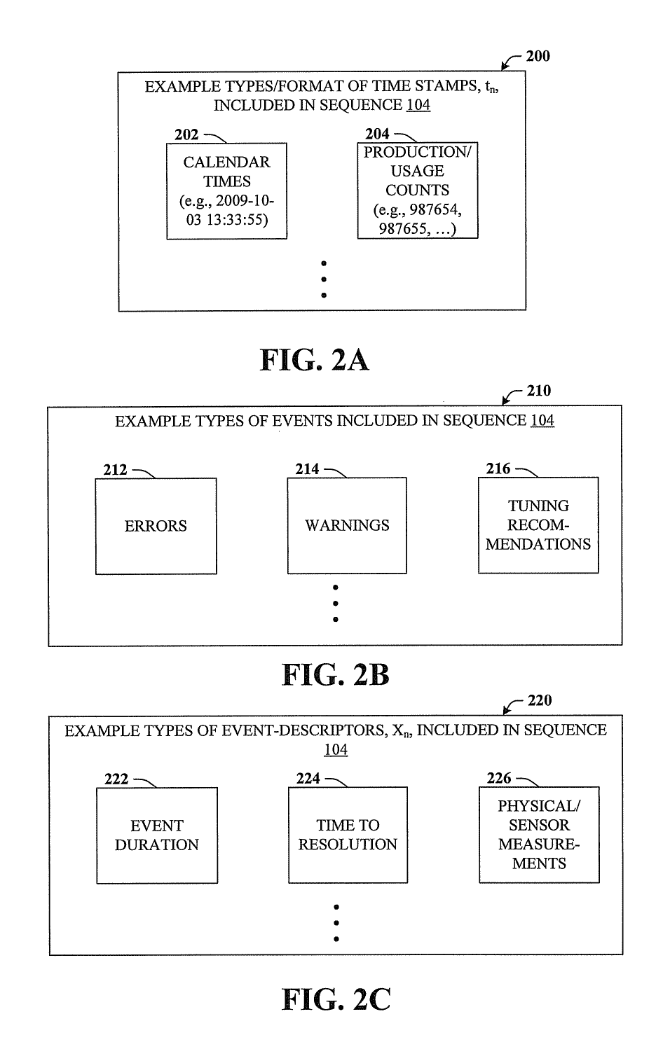

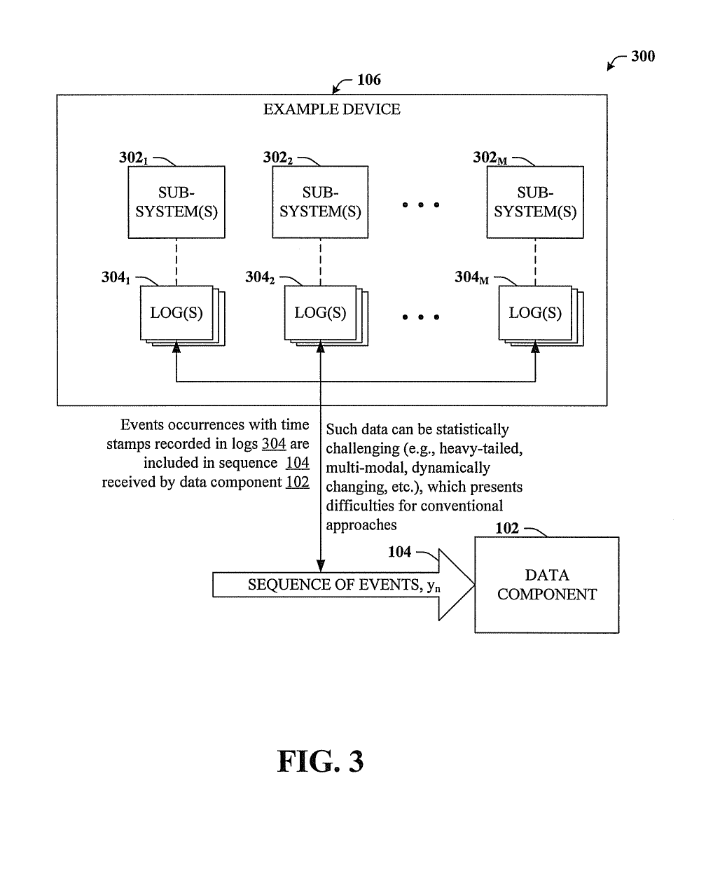

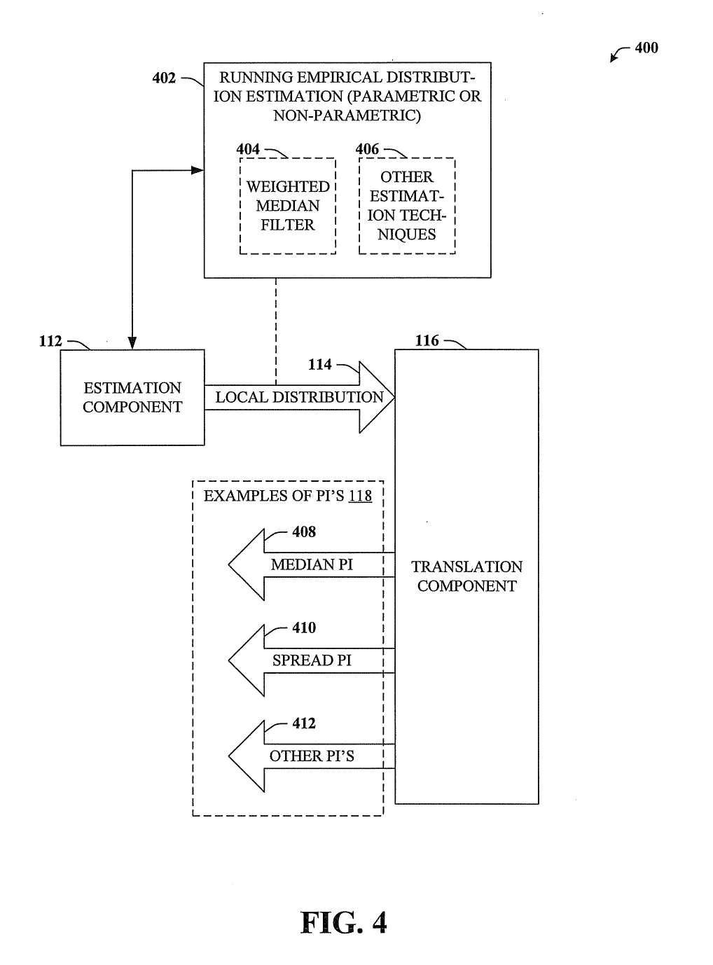

Data component 102 can be configured to receive sequences 104 of time stamped events and event-descriptors associated with device 106 and/or associated with subsystems of device 106. For ease of description, a given sequence 104 can be referred to as input data, yₙ={tₙ, Xₙ} which can relate to a collection of event sequences or streams time-stamped by tₒ and related event-descriptors Xₙ (Xₙ is optional). Sequences 104 can correspond to occurrences of a single event-type (e.g., a particular type of event) or to an aggregation of occurrences of similar event-types (e.g., generated by the same subsystem). Time stamps tₙ associated with events can be generalized and are not limited to actual time, which is further detailed with reference to FIG. 2A. Events can relate to undesirable occurrences, various examples of which are provided in connection with FIG. 2B. Event descriptors, Xₙ, received by data component 102 can correspond to the event duration, time-to-event-resolution or substantially, any relevant signal from device 106 or associated subsystems or components of device 106 measured/logged in conjunction with the event occurrence (temperature, humidity at the time of event occurrence, etc.).

While still referring to FIG. 1, but turning also to FIGS. 2A, 2B, and 2C, block representations 200, 210, and 220 are provided. Block representation of time stamps 200 provides various example types or formats of time stamps associated with events that can be included in sequences 104. For instance, the time stamps can relate to calendar time 202, which can represent dates and/or times in which events occurred. In some embodiments, time stamps can relate to production/usage counts 204 such as an incremental numbering of products or services provided (e.g., number of goods produced, number of sheets of paper copied/printed, . . . ). Thus, time stamps can be of a general nature and other suitable types or formats can be employed.

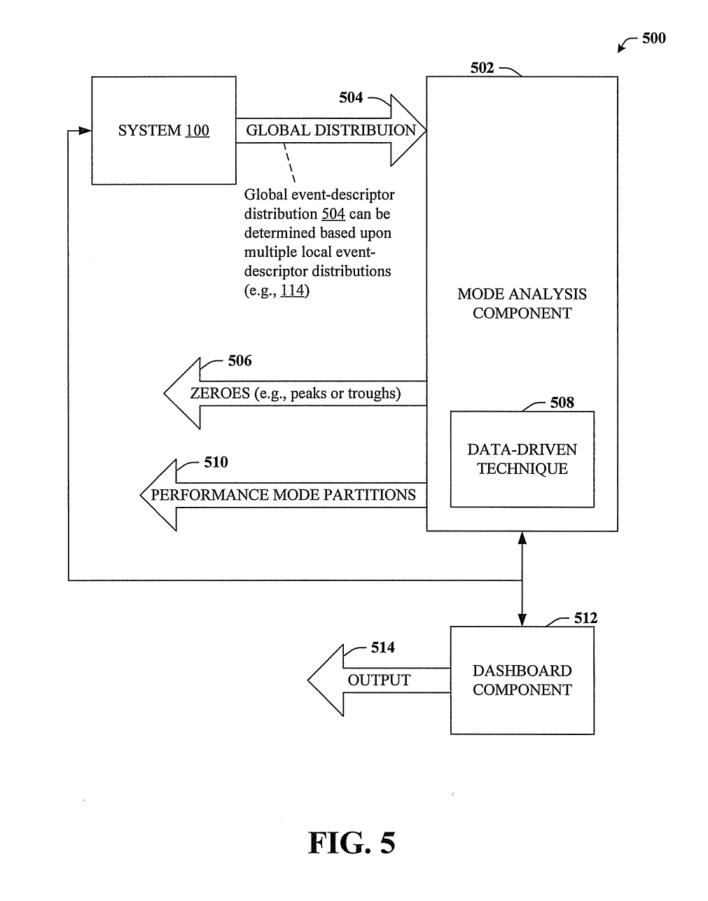

Block representation of events 210 provides various example types of events for which associated data can be included in sequences 104. For instance, events can relate to errors 212 (e.g., a paper jam), warnings 214 (e.g., low on toner/ink), tuning recommendations 216 (e.g., tighten loose belt), and so forth. Generally, events can relate to states of associated devices that are undesirable or otherwise noteworthy. Such events are typically recorded in log(s) associated with device 106, as further detailed in connection with FIG. 3, which can now be referenced in conjunction with FIG. 1.

Block representation 220 of event-descriptors provides various examples of event-descriptor data associated with events that can be included in sequences 104. For instance, event descriptors can correspond to event-duration 222, either in terms of time or in terms of generalized time as defined above. As another example, event descriptors can correspond to the time to resolution 224, which can relate to a time required to resolve the problem corresponding to an event. In some embodiments, event descriptors can relate to physical measurements 226 of the related device or device-component at the time of the event, such as temperature, pressure, electrical voltage, etc.

FIG. 3 illustrates system 300 in which data associated with event logs are included in sequences 104. As depicted, device 106 can include substantially any number, M, of machines, devices, systems, subsystems, or the like, denoted here as subsystems 302₁-302_{M}. Although subsystems 302₁-302_{M} can include distinct characteristics, such is denoted herein, either collectively or individually, as subsystem(s) 302, with appropriate subscripts employed generally only when instructive or convenient to highlight various distinctions or to better impart the disclosed concepts. Subsystem 302 can be, for example, computers, machinery with computer-based processors, mechanical/electronic equipment, digital systems, medical monitoring systems, sensors, or substantially any apparatus that can be coupled to a monitoring system. Typically, subsystems 302 will maintain logs, denoted logs 304₁-304_{M}, which record various events (e.g., events 210, etc.) as well as an associated time stamp (e.g., time stamps 200, etc.). As used herein, logs 304₁-304_{M} can also be referred to either individually or collectively as logs 304. A given subsystem 302 can maintain multiple logs 304. In other embodiments, subsystems 302 can generate events for a single log associated with device 106. However, it is appreciated that in either case, a first subsystem 302 can generate a different set of log events than a second subsystem 302, which can be related to or triggered by other subsystems 302 or associated events.

Data associated with events and with associated time stamps for those events can be included in sequence 104 that is received by data component 102. Given that a great deal of time (either temporal, counts, or otherwise) can pass between event occurrences in some cases but not in other cases, such data can be stochastically and/or statistically challenging, e.g., heavy-tailed such that a tail is heavier or denser with points at the tail than the exponential distribution. The notion of heavy-tailedness can be carried on as an example for stochastic challenges of the data. It should be understood, that any other example of stochastically challenging data (multi-modal, time-varying distributions, etc.) can be incorporated in the scheme described henceforth. The heavy-tailed case can occur for both events of a similar type or combinations of events of different types. As noted, such heavy-tailed cases can present difficulties for conventional approaches. However, such difficulties can be overcome as further detailed herein.

Still referring to FIG. 1, data included in sequences 104 (e.g., input data, yₙ, received from logs 304) can be forwarded to conversion component 108. Conversion component 108 can be configured to convert sequences 104 to associated time series 110 that corresponds to the raw performance data to be analyzed, which is for convenience denoted Yₙ for certain specific cases, or Y*ₙ for generalized cases. Conversion component 108 can convert event-descriptors Xₙ of a given sequence 104 to time series 110 associated with an event count axis related to events 210: Yₙ=Xₙ(tₙ). For instance, a count of events 210 can represent a generalized time axis rather than actual event times as is done conventionally. For event-occurrence data, conversion component 108 can convert the series of generalized time-stamps tₙ into a series of event descriptor values corresponding to differences between consecutive events time-stamps, which we denote by the term “event-intervals”. The event-interval series are obtained as follows: Yₙ=tₙ−tₙ₋₁. For cases where the event-data contains time-stamps solely, i.e., no additional event-descriptors are provided and Xₙ is an empty set, the analysis is performed on the above-defined event-intervals descriptor series derived from the events series. It is worth noting that contrary to prior solutions that utilize event-counts as the raw data to be analyzed, this invention avoids fixing a time-slot and analyses the event-intervals series directly. The same avoidance of time-slot fixing is applied in general in analysis of any of the event-descriptors. In some embodiments, conversion component 108 can convert sequence 104 to time series 110 based upon a variance stabilization transformation of the raw performance data Yₙ. A common example of the variance stabilization transformation can be a log transformation of event-intervals associated with events 210.

For instance, time series 110 (e.g., with Yₙ representing the raw performance signal/data) can be further transformed based upon the following example log transformation: Y*ₙ=log₁₀(s+Yₙ), where the time axis can be the event-interval count, denoted by n (given the time axis need not be a temporal measurement), and s can be a small regularization constant. As a result, erratic event data, often with heavy-tailed distributions, is converted to a more uniform time series or a series in event counts, such that the variance of the transformed series does not change as much over time. Such can be applied to analysis of not only time series that emerge from event-intervals data, but for any event-descriptors Yₙ that may have heavy-tailed distributions such as, e.g., time-to-fix-the-incident measurements versus the times of incident occurrences. For example, in the latter case, the appropriate time series can be these time-to-fix values (possibly transformed) rather than time between the incidents, which is further detailed below. Other event descriptors, such as temperature measurements may not require this variance stabilization transformation.

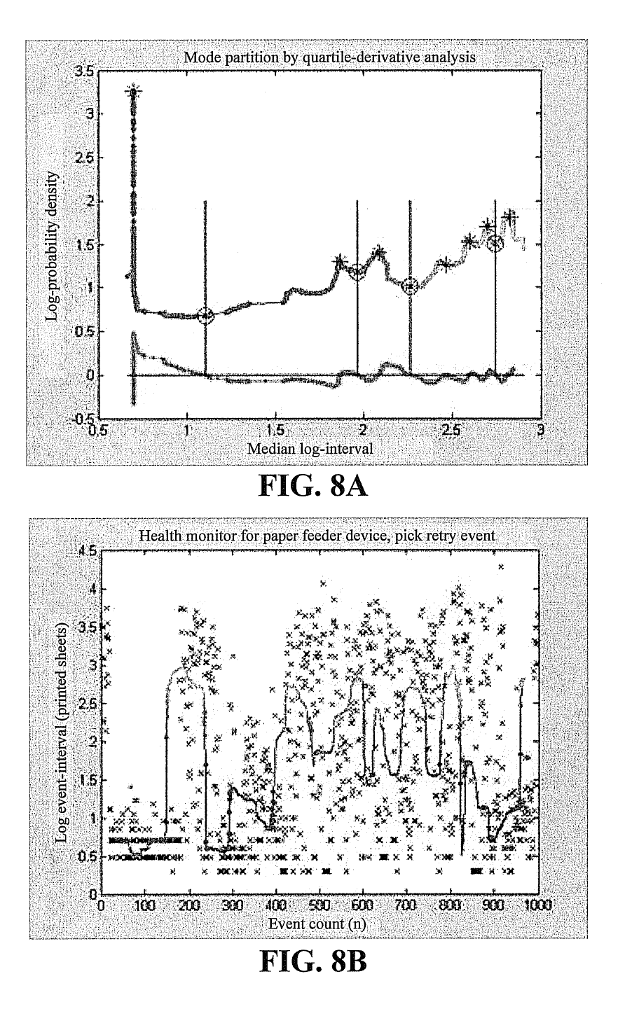

While the raw performance signal, Yₙ, can be heavy-tailed and a subsequent variance stabilization transformation can be useful for analysis of Yₙ, it is possible in some situations to get quite good results by considering the local interval-descriptive distribution of the event-interval signal, Yₙ, even without the log transformation, such as when no local sample values are combined by addition operations. For example, the median of the local distribution can be computed to represent a representative event-interval value. Such can be effective despite the heavy-tail since the median can select the value of a single (“central”) sample in the local window without involving addition operations between sample values. Moreover, it should be underscored that that the transformation into event intervals and event-count axis operates on the domain-axis (e.g., x-axis in certain illustrative graphs provided in connection with FIGS. 6A-8B), while the subsequent log transformation or other variance stabilization transformation operates on the range-axis (e.g., y-axis in certain illustrative graphs of FIGS. 6-8). Therefore, these various transformations can be applied independently of each other.

It is understood that the role of the log transformation or other variance stabilization transformations can be to enable better or more robust estimation of characteristics of the local event-descriptor distributions other than the “central”-value. In particular, estimation of distribution shape attributes such as width, lower/upper tailedness, number of modes, etc. can involve consideration of sample value differences, and can be sensitive to extreme values (outliers) such as in heavy-tailed distributions. A variance stabilization transformation can reduce this sensitivity considerably. In principle one might estimate from the data what would be an optimal variable stabilization transformation under some optimality criterion. One reason to choose log transformations over other variance stabilization alternatives is that graphs in the log-domain are easy to interpret and understand by the consumers of the technology, such as field engineers. Thus, to reiterate, a general variance stabilization transformation formula can be provided as: Y*ₙ=log₁₀(s Yₙ).

Regardless of the particular implementation, estimation component 112 can receive time series 110 data and can be configured to estimate local event-descriptor distributions characteristics 114 at an event-interval count (e.g., n) associated with time series 110 (e.g., Y*ₙ). For example, given Y*ₙ, estimation component 112 can estimate representative distribution characteristics (e.g., median, mean and other local event-rate distribution characteristics 114) at point n of the data-sequence, based on the local neighborhood window about n. Translation component 116 can be configured to translate local event-descriptor distributions characteristics 114 into performance indicators 118, which can be denoted PIₙ.

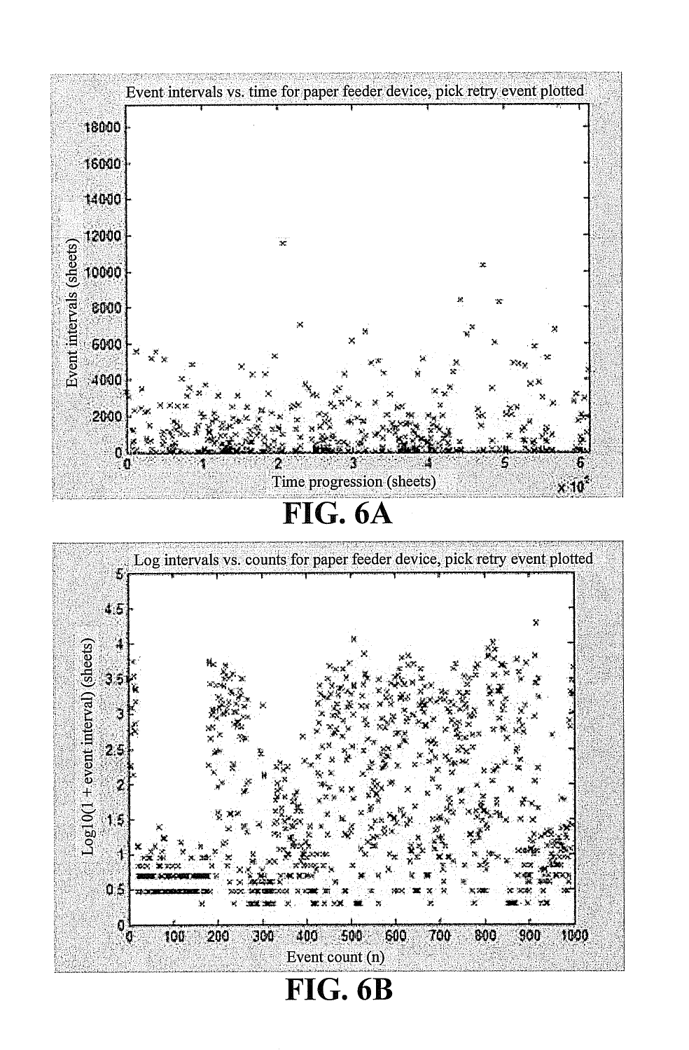

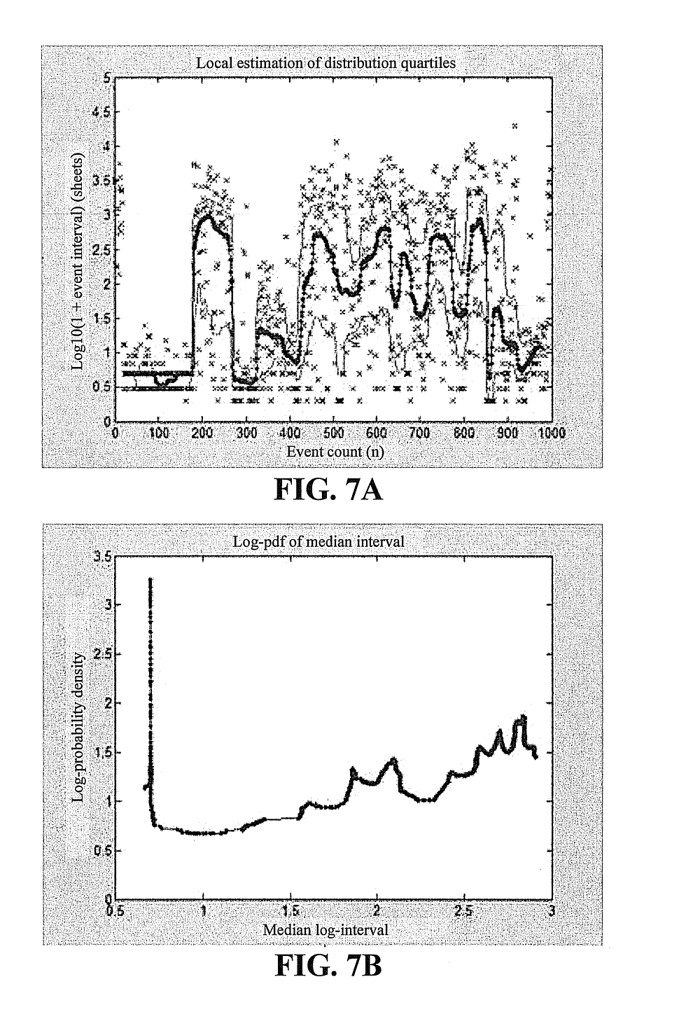

With reference now to FIG. 4, system 400 is depicted. System 400 can provide additional detail in connection with estimation components 112 and translation components 116. For example, in some embodiments, estimation component 112 can estimate local event-descriptor distribution characteristics 114 based upon a filter 402 of a local section of the event-interval count (e.g., a local window about n). For example, filter 402 can relate to a running empirical distribution estimation (parametric or non-parametric). One example of filter 402 can be weighted median filter 404. However, other data-driven estimation techniques (parametric or non-parametric) 406 can be employed, e.g., quantiles-based CDF estimation or more sophisticated parametric or non-parametric filtering. For cases where partial estimation of the empirical-CDF suffices, weighted median or mean filters, running standard deviation filters and other filters and estimators can be applied. In some embodiments, estimation component 112 can determine a global event-descriptor distribution based upon multiple local event-descriptor distributions 114, which is further described in connection with FIG. 5.

When operating upon a streaming time series such as Y*ₙ, ongoing mean/median filters can provide mean/median event-intervals. It is noted that these event-intervals and associated event-rates are reciprocals of one another. Hence, real-time monitoring can be provided automatically in a time-adaptive fashion. Thus, while other filters 402 can be utilized, for the remainder of the description, it is assumed weighted median filter 404 is applied over blocks or windows of data points of size N (e.g., N=10, 20 . . . ) in connection with estimating local event-rate distributions characteristics 114.

For each n, and for a block of size N (where the N-sized window includes data point n), per-block empirical cumulative distribution characteristics (e.g. quartiles) can be estimated. If the scenario is non-causal, n can be located in the center of the block/window. Block points can be treated either as equal weights, or triangular weighting profiles centered at n can be used, e.g., to provide higher weights in proximity to n. If such representative data have smaller than a half-N look-ahead, profiles with forgetting factors for points older than the look-ahead can be used. In cases of causal (e.g., on-line) operation, a single-block estimator with a forgetting factor can be used.

Translation component 116 can then provide associated performance indicators 118. For example, a first performance indicator 118 can be median performance indicator 408, which can be derived by applying weighted median filter 404 to the local section of the event-interval count, n. In other examples, translation component 116 can provide spread performance indicator 410 as well as other indicators 412. For example, while utilizing the same filter (e.g., weighted median filter 404) used to construct median performance indicator 408, other performance indicators 412 can be extracted by calculating other quartiles and/or other inter-quartile distances. Such can provide an approximated distribution spread, for instance. In the case of spread performance indicator 410, the spread of Y*ₙ values can be obtained by the median absolute deviation from the median of the block/window. For example, higher values might indicate that transition between two dense distributions has occurred.

Advantageously, the above described estimation is suitable for the times of actual event occurrences (e.g., represented by the event counts in the representation of Y*ₙ). In order to efficiently provide continuous monitoring as well as to efficiently compare performance of events that occurred at different times, performance estimations both at times between event occurrences and between the last occurrence and the present can be examined. Interpolation methods, linear or otherwise, between PIₙ can aid the former, but typically do not solve the issue of present performance estimation, particularly for on-line or causal cases. However, in those latter cases, rather than employing heuristic techniques such as zero-order-hold, a more statistically sound estimator can be employed. For instance, considering the interval from current-time to last event-occurrence as a censored sample and applying efficient techniques to compute a Kaplan-Meier estimator can be utilized.

Turning now to FIG. 5, system 500 is illustrated. System 500 can provide for mode analysis and output presentation in connection with translating time-stamped events to performance indicators. In particular, system 500 can include all or portions of system 100 or other components described herein. For example, system 100 can include estimation component 112 that can estimate local event-descriptors distributions characteristics 114. In addition, estimation component 112 can determine global event-descriptors distributions 504 based upon multiple local event-descriptors distributions 114. The estimation component 112 can apply different methods for estimation of local and global descriptors distributions (or distribution characteristics). For example, a global event-descriptor distribution 504 of the event-descriptor can be based upon the entirety of a particular performance indicator 118 (e.g., median performance indicator 408, to continue the example from above) accumulated to n. In some embodiments, global event-descriptors distributions 504 need not be estimated for every n, but rather only occasionally. For example, such estimations can be daily, weekly, etc. and can be user- or administrator-defined.

System 500 can also include mode analysis component 502 that can receive global event-descriptor distribution 504. Mode analysis component 502 can be configured to determine significant peaks and trough of global event-descriptor distribution 504. For example, mode analysis component 502 can determine meaningful peaks and troughs, e.g., by determining the zeroes 506 of the appropriate function. Advantageously, such can be accomplished by way of data-driven technique 508, such as a non-parametric quantiles-based procedure that can be more robust than conventional approaches. It is appreciated that parametric techniques might also be used in other embodiments. Mode analysis component can also partition ranges of global event-descriptor distributions 504 into performance modes partitions 510 that relate to the performance mode of device 106. Performance mode partitions 510 can be bounded by two consecutive toughs.

In more detail, by employing non-parametric techniques 508, smoother, derivatives of distribution functions can be computed. For example, these distribution functions can be computed based upon measuring widths of intervals including a fixed distribution mass (e.g., five percent of the data). Zeroes 506 can be computed based upon smoothed second-derivatives of performance indicators 118. Performance mode partitions 510 can be identified and applied over the entire value range. Furthermore, preprocessing by smoothing the global distribution can be included as well. For instance, the preprocessing can be accomplished by applying the aforementioned mode detection.

According to the disclosed approach, mode analysis component 502 can identify relatively small modes, which represents yet another advantage over many conventional approaches. For example, events generated by complex systems often include many small performance modes, and mode analysis component 502 can identify these modes as meaningful or significant when sufficiently represented in the data, such as, e.g., representing ten percent of the data. Mode analysis component 502 can also set the “best” performance threshold to the maximal event-rate value of the lowest mode (e.g., in terms of event-rates), and set the “worst” threshold in a converse fashion. For cases where low or intermediate event-descriptor values indicate desirable system behavior, the performance thresholds can be adjusted accordingly.

Such thresholds can be further adjusted, by examining other quantiles of performance indicators 118 and updating threshold values based on the operation modes spreads or the like. The performance indicators 118 can be normalized to the range between the “worst”-thresholds (e.g., ˜0%-performance) and the “best” thresholds (e.g., 100%-performance). Hence, determination of stable operation modes can be more accurate by selectively weighting out data from transition periods, which can be accomplished by weighting data blocks inversely to an associated spread performance indicator 410.

System 500 can also include dashboard component 512 that can be configured to present output 514 (e.g., to a display device) associated with local event-descriptors distributions 114, global event-descriptors distributions 504, or other data described herein. Dashboard component 512 can also provide an interface to configure various variables or settings associated with the disclosed subject matter. As a various examples of output 514 that can be presented by dashboard component 512, FIGS. 6A-8B are provided.

FIGS. 6A-8B relate to various example illustrative graphs and/or graphical representations of data detailed herein. In particular, FIG. 6A plots event-intervals over time for a subsystem (e.g., one example of subsystem 302) with a paper feeder. In this case, event-intervals relate to a number of sheets of paper processed (rather than actual calendar time) and the event-interval plotted relates to a “pick-retry” event (e.g., a sheet was not properly obtained by the paper feeder), which can be recorded in logs associated with the device. These logs (as well as those for other devices) can be examined, and event 210 data and time stamp 200 data can be extracted and received by data component 102 as sequence 104 in the form of yₙ=tₙ, where tₙ are the generalized time-stamps corresponding to the number of sheets issued by the printer.

Conversion component 108 can convert sequences 104 to time series 110 based upon a log transformation of event-intervals associated with the events. Thus, event-intervals, yₙ, can be converted to time series, Y*ₙ, e.g., according to Y*ₙ=log 10(1ₛₕₑₑₜ+yₙ−yₙ₋₁). FIG. 6B depicts a plot of log intervals over event counts, which can be derived conversion component 108 from the data associated with FIG. 6A. Data points derived there from can be smoother than the plot of FIG. 6A, and more meaningful in terms of human concepts. For instance, the transformation can provide variance normalization, such that the order of magnitude remains rather than merely the magnitude itself. Hence, the transformation can operate to both smooth the original data as well as converting the original data into more meaningful and human-comprehensive scale. Nevertheless, there are cases where variance stabilization is not necessary or can be performed differently.

For event-rate analysis, such data-transformation provides a significant advantage over prior approaches of event-counts per fixed time window. The computation of event-rate according to the disclosed representation can become equivalent to filtering or smoothing of the event-interval generalized time-series. Thus, all prior knowledge from the field of signal/time-series analysis can be leveraged, as has been illustrated herein. Another advantage of the proposed data representation can be that, unlike in prior approaches, fixed size context-windows contain the same number of data-points (e.g., event-intervals), and therefore have the same degree of statistical validity as other windows.

Estimation component 112 can derive local event-rate distributions characteristics from the smooth time series, Y*ₙ, and translation component 116 can translate the local event-rate distributions to performance indicators. Such is illustrated by FIG. 7A. Estimation component 112 can provide performance indicators that are related to dynamic properties of distributions, such as possibility of change in distribution in each window or the like. Estimation component 112 can also compute global event-rate distributions and translation component 116 can provide the aggregate performance indicators over the global data, which is depicted in FIG. 7B.

Mode analysis component 502 can determine significant peaks and troughs of the global event-rate distributions and partition ranges of global event-rate distributions into multiple performance modes for the device. Such performance modes can be bounded by two consecutive troughs, which is illustrated by FIG. 8A. FIG. 8B relates to a health monitor for the paper feeder device that plots event counts over a log of event-intervals. Such can be provided by dashboard component 514 to, e.g., provide relevant information to service or management staff.

It is appreciated that the disclosed subject matter can provide a significant advantage over prior approaches is the generality and independence of statistical model assumptions. Furthermore, the disclosed subject matter can support statistically challenging distributions as well. Another advantage is that “best” performance thresholds and “worst” performance bounds of each system can be determined, even when a relatively small percentage of a device's time is spent in these performance modes. Such can be contrasted with prior mode-analysis methods that typically focus exclusively on the most massive main modes.

Such technical advantages can translate into practical advantages for decision/support information staff. In particular, the data can be adapted to the history of the monitored system. For example, alarms on reduction in performance relative to performance-bound can be determined from self-history associated with specific devices rather than based upon predefined or default setting. Further, proactive and post-maintenance monitoring can be readily indicated by reduced event-rates.

Such can be advantageous given that adaptation to history can be quite relevant. For example, systems that operate under different conditions or with different work patterns/loads do not obey the same performance thresholds that are set by the manufacturer. Two otherwise identical systems can yield very different sets of events of the same type based upon differences in the work load alone. For example, a first system that operates at under a slightly higher work load or a different work pattern can result in numerous events, whereas a second (otherwise identical) system can be relatively event-free. Thus, based only on manufacturer performance indicators, one system might always perform “well” while the other will always perform badly, when in fact, each system has its individual (workload driven) performance.

Moreover, the disclosed subject matter can be generic to the device type or types. Thus, techniques described herein can be applied to wide variety of systems, such as substantially any system that report and/or records event-logs. Furthermore, a further advantage of the disclosed subject matter can be simplicity of implementation, low complexity, and ready adaptation to existing architecture. For example, the disclosed subject matter can be implemented either as software or as hardware, given many advantages can be achieved by way of sorting operations. Such operations do not require large memory resources and can be pluggable in many existing environments for system monitoring, both in causal and non-causal variations.

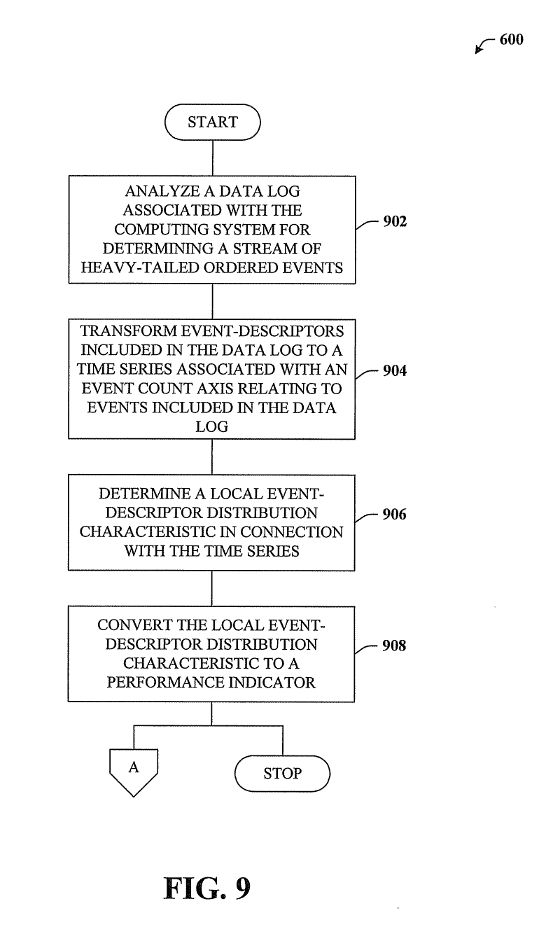

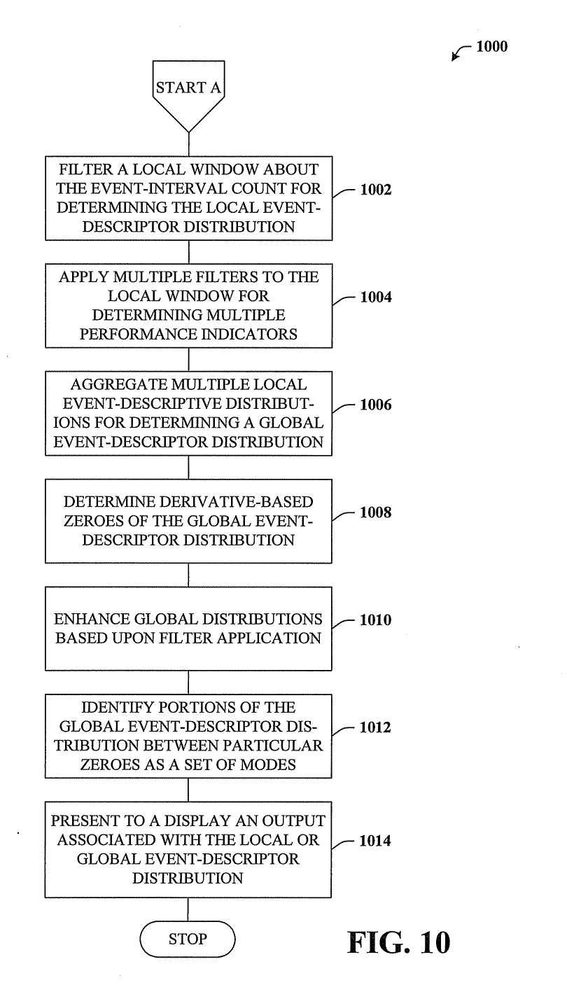

FIGS. 9 and 10 illustrate various methodologies in accordance with certain embodiments of this disclosure. While, for purposes of simplicity of explanation, the methodologies are shown and described as a series of acts within the context of various flowcharts, it is to be understood and appreciated that embodiments of the disclosure are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. For instance, as detailed previously, conversion to a series of event counts can relate to time series that emerge from event-interval data or substantially any non-uniform discrete event data (e.g., time-to-fix-the-incident versus the times of incident occurrences). Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers. The term article of manufacture, as used herein, is intended to encompass a computer program accessible from any computer-readable device or storage media.

FIG. 9 illustrates example method 900. Method 900 can provide for constructing performance indicators based upon time-stamped events. For example, at reference numeral 902, data logs associated with a computing system (or device, or subsystems of the device) can be analyzed, for example by a data component. Based upon the analysis, a stream of time-stamped or ordered events can be identified along with associated event-descriptors. The stream of events can be heavy-tailed, e.g., due to the fact that the events occur at dramatically different scales of “time”.

At reference numeral 904, event-descriptors included in the data log can be transformed to a generalized time series, for example by a conversion component. The generalized time series can be associated with an event count axis relating to events included in the data log. This generalized time series can be more uniform and intuitive than the associated event-interval data and can lead to more robust and more efficient analysis.

At reference numeral 906, local event-descriptor distribution characteristics can be determined, for example by an estimation component. The local event-descriptor distribution characteristics can be computed at event-interval counts of the time series. At reference numeral 908, the local event-descriptor distribution characteristics can be converted to various performance indicators, for instance, by a translation component.

Turning now to FIG. 10, example method 1000 is depicted. Method 1000 can provide for additional features associated with constructing performance indicators based upon time-stamped events. As noted previously, at reference numeral 906 of FIG. 9, local event-rate distributions can be determined at event-interval counts of the time series by an estimation component. For example, in some embodiments, a local window about the event-interval counts can be filtered for determining local event-descriptor distributions characteristics, as indicated at reference numeral 1002. For instance, a predetermined filter can be applied in this regard, which can be a weighted median filter, a weighted mean filter, or some other type of filter.

At reference numeral 1004, multiple filters can be applied to the local window for determining multiple performance indicators. In other embodiments, multiple performance indicators can be derived from a single filter utilized at reference numeral 1002.

At reference numeral 1006, multiple local event-descriptors distributions characteristics (of the same type) can be aggregated for determining global event-descriptor distributions. At reference numeral 1008, derivative-based (e.g., second-order derivatives) zeroes of the global event-rate distribution can be determined. It is understood that other mechanisms other than derivative-based zeroes can be employed to identify peaks or troughs. At reference numeral 1010, global distributions can be enhanced based upon applications of various filters. For example, at reference numeral 1004, multiple filters can be applied to a local window for a variety of purposes. Such can be employed to obtain various performance indicators, as well as to perform correct filtering of the local window and obtain the “right” local distribution. For instance, smoothing and enhancing filters can be applied in order to enhance the global distribution prior to mode-partitioning.

At reference numeral 1012, portions of the global event-descriptors distributions that exist between particular zeroes can be identified as a set of performance modes, for example, by a mode analysis component. At reference numeral 1014, an output associated with local event-descriptors distributions characteristics or global event-descriptors distributions (or data relating thereto) can be presented to a display.

### Example Component Architecture

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

With reference to FIG. 11, a suitable environment 1100 for implementing various aspects of the claimed subject matter includes a computer 1102. The computer 1102 includes a processing unit 1104, a system memory 1106, a codec 1135, and a system bus 1108. The system bus 1108 couples system components including, but not limited to, the system memory 1106 to the processing unit 1104. The processing unit 1104 can be any of various available processors. Dual microprocessors and other multiprocessor architectures also can be employed as the processing unit 1104.

The system bus 1108 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1106 includes volatile memory 1110 and non-volatile memory 1112. The basic input/output system (BIOS), containing the basic routines to transfer information between elements within the computer 1102, such as during start-up, is stored in non-volatile memory 1112. In addition, according to present innovations, codec 1135 may include at least one of an encoder or decoder, wherein the at least one of an encoder or decoder may consist of hardware, software, or a combination of hardware and software. Although, codec 1135 is depicted as a separate component, codec 1135 may be contained within non-volatile memory 1112. By way of illustration, and not limitation, non-volatile memory 1112 can include read only memory (ROM), programmable ROM (PROM), electrically programmable ROM (EPROM), electrically erasable programmable ROM (EEPROM), or flash memory. Volatile memory 1110 includes random access memory (RAM), which acts as external cache memory. According to present aspects, the volatile memory may store the write operation retry logic (not shown in FIG. 11) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1102 may also include removable/non-removable, volatile/non-volatile computer storage medium. FIG. 11 illustrates, for example, disk storage 1114. Disk storage 1114 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1114 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1114 to the system bus 1108, a removable or non-removable interface is typically used, such as interface 1116. It is appreciated that storage devices 1114 can store information related to a user. Such information might be stored at or provided to a server or to an application running on a user device. In one embodiment, the user can be notified (e.g., by way of output device(s) 1136) of the types of information that are stored to disk storage 1114 and/or transmitted to the server or application. The user can be provided the opportunity to opt-in or opt-out of having such information collected and/or shared with the server or application (e.g., by way of input from input device(s) 1128).

It is to be appreciated that FIG. 11 describes software that acts as an intermediary between users and the basic computer resources described in the suitable operating environment 1100. Such software includes an operating system 1118. Operating system 1118, which can be stored on disk storage 1114, acts to control and allocate resources of the computer system 1102. Applications 1120 take advantage of the management of resources by operating system 1118 through program modules 1124, and program data 1126, such as the boot/shutdown transaction table and the like, stored either in system memory 1106 or on disk storage 1114. It is to be appreciated that the claimed subject matter can be implemented with various operating systems or combinations of operating systems.

A user enters commands or information into the computer 1102 through input device(s) 1128. Input devices 1128 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1104 through the system bus 1108 via interface port(s) 1130. Interface port(s) 1130 include, for example, a serial port, a parallel port, a game port, and a universal serial bus (USB). Output device(s) 1136 use some of the same type of ports as input device(s) 1128. Thus, for example, a USB port may be used to provide input to computer 1102 and to output information from computer 1102 to an output device 1136. Output adapter 1134 is provided to illustrate that there are some output devices 1136 like monitors, speakers, and printers, among other output devices 1136, which require special adapters. The output adapters 1134 include, by way of illustration and not limitation, video and sound cards that provide a means of connection between the output device 1136 and the system bus 1108. It should be noted that other devices and/or systems of devices provide both input and output capabilities such as remote computer(s) 1138.

Computer 1102 can operate in a networked environment using logical connections to one or more remote computers, such as remote computer(s) 1138. The remote computer(s) 1138 can be a personal computer, a server, a router, a network PC, a workstation, a microprocessor based appliance, a peer device, a smart phone, a tablet, or other network node, and typically includes many of the elements described relative to computer 1102. For purposes of brevity, only a memory storage device 1140 is illustrated with remote computer(s) 1138. Remote computer(s) 1138 is logically connected to computer 1102 through a network interface 1142 and then connected via communication connection(s) 1144. Network interface 1142 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1144 refers to the hardware/software employed to connect the network interface 1142 to the bus 1108. While communication connection 1144 is shown for illustrative clarity inside computer 1102, it can also be external to computer 1102. The hardware/software necessary for connection to the network interface 1142 includes, for example purposes only, internal and external technologies such as, modems including regular telephone grade modems, cable modems and DSL modems, ISDN adapters, and wired and wireless Ethernet cards, hubs, and routers.

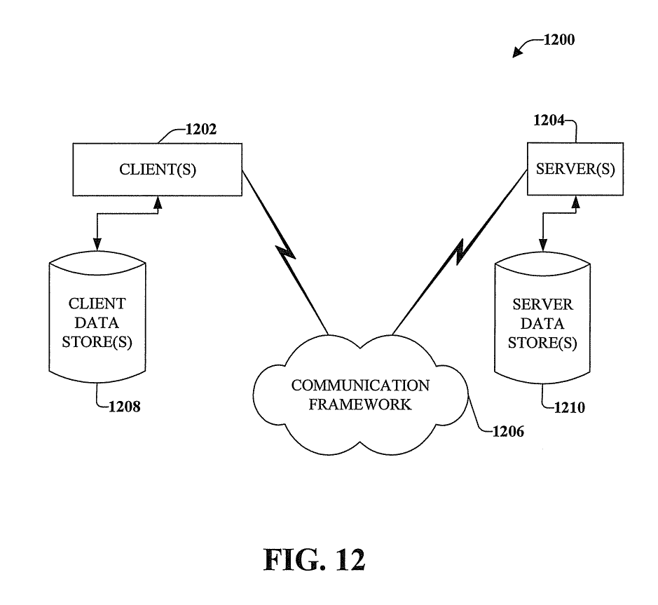

Referring now to FIG. 12, there is illustrated a schematic block diagram of a computing environment 1200 in accordance with this specification. The system 1200 includes one or more client(s) 1202 (e.g., laptops, smart phones, PDAs, media players, computers, portable electronic devices, tablets, and the like). The client(s) 1202 can be hardware and/or software (e.g., threads, processes, computing devices). The system 1200 also includes one or more server(s) 1204. The server(s) 1204 can also be hardware or hardware in combination with software (e.g., threads, processes, computing devices). The servers 1204 can house threads to perform transformations by employing aspects of this disclosure, for example. One possible communication between a client 1202 and a server 1204 can be in the form of a data packet transmitted between two or more computer processes wherein the data packet may include video data. The data packet can include a cookie and/or associated contextual information, for example. The system 1200 includes a communication framework 1206 (e.g., a global communication network such as the Internet, or mobile network(s)) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

In one embodiment, a client 1202 can transfer an encoded file, in accordance with the disclosed subject matter, to server 1204. Server 1204 can store the file, decode the file, or transmit the file to another client 1202. It is to be appreciated, that a client 1202 can also transfer uncompressed file to a server 1204 and server 1204 can compress the file in accordance with the disclosed subject matter. Likewise, server 1204 can encode video information and transmit the information via communication framework 1206 to one or more clients 1202.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated example aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

What is claimed is:

1. A system that translates time-stamped events to performance indicators, comprising:
a memory that stores computer executable components; and
a processor that executes the following computer executable components stored in the memory:
a data component that receives a sequence of time-stamped events and event-descriptors associated with a device that includes a set of subsystem components;
a conversion component that converts the sequence of event-descriptors to a generalized time series associated with an event count axis related to the events;
an estimation component that estimates a local event-descriptor distribution characteristic associated with the generalized time series; and
a translation component that translates the local event-rate distribution characteristic into a performance indicator.

2. The system of claim 1, wherein the event-descriptors are the intervals between consecutive similar events and the conversion component converts the sequence to a time series based upon a variance stabilization transformation of the event-descriptors associated with the event count axis and the estimation component estimates the local event-rate distribution characteristic at an event-interval count associated with the generalized time series.

3. The system of claim 2, wherein the variance stabilization transformation is a log transformation.

4. The system of claim 1, wherein time stamps associated with the events relate to calendar times, usage counts, or production counts.

5. The system of claim 1, wherein an event-descriptor distribution of the events is statistically challenging.

6. The system of claim 1, wherein the estimation component estimates the local event-descriptor distribution characteristic based upon a filter of a local section of the event-descriptor series.

7. The system of claim 6, wherein the filter is a weighted median filter and the translation component determines a first local event-descriptor distribution characteristic based upon a weighted median filter applied to the local section and a second local event-descriptor distribution characteristic based upon a median absolute deviation applied to the local section.

8. The system of claim 6, wherein the estimation component determines a global event-descriptor distribution characteristic based upon multiple local event-descriptor distributions.

9. The system of claim 8, further comprising a mode analysis component that determines significant peaks and troughs of the global event-descriptor distribution based upon a data-driven technique and partitions ranges of the global event-descriptor distribution into performance modes for the device, the performance modes bounded by two consecutive troughs.

10. The system of claim 9, further comprising a dashboard component that presents output associated with the local event-descriptor distribution or the global event-descriptor distribution and derived performance indicators.

11. A method for constructing performance indicators based upon time-stamped events, comprising:
employing a computer-based processor to execute computer executable components stored in a memory to perform the following:
analyzing a data log associated with a device with multiple subsystems for determining a stream of ordered events;
transform event-descriptors determined from the data log to a generalized time series associated with an event count axis relating to events included in the data log;
determining a local event-descriptor distribution characteristic in connection with the generalized time series; and
converting the local event-descriptor distribution characteristic to a performance indicator.

12. The method of claim 11, further comprising utilizing a log transformation of event-descriptors for transforming the stream of ordered events to the generalized time series.

13. The method of claim 11, further comprising filtering a local window about a particular event count for determining the local event-descriptor distribution characteristic.

14. The method of claim 13, further comprising applying multiple filters to the local window for determining multiple performance indicators and identifying a suitable distribution characteristic and aggregating multiple local event-descriptor distribution characteristics for determining a global event-descriptor distribution.

15. A method for identifying performance modes, comprising:
employing a computer-based processor to execute computer executable components stored in a memory to perform the following:
transforming event-descriptors of a stream of events identified in a data log associated with a set of device subsystems to a time series;
determining a performance indicator based upon a local event-descriptor distribution associated with a local event count of the time series;
determining a global event-descriptor distribution from multiple local event-descriptor distribution characteristics;
employing data-driven analysis for determining peaks and valleys of the global event-descriptor distribution; and
identifying performance modes over ranges of the global event-descriptor distribution bounded by two consecutive valleys of a sufficiently meaningful mode.
